(19) United States
(12) Patent Application Publication
(10) Pub. No.: US 2017/0148558 A1
(43) Pub. Date: May 25, 2017

(54) INDUCTOR AND INDUCTOR MODULE

(71) Applicant: MEDIATEK INC., Hsin-Chu (TW)

(72) Inventors: Huan-Sheng Chen, Tainan City (TW); Yen-Ju Lu, New Taipei City (TW); Chung-Shi Lin, Hsinchu City (TW); Chien-Hua Wu, Taipei City (TW); Yan-Bin Luo, Taipei City (TW)

(21) Appl. No.: 15/135,558

(22) Filed: Apr. 22, 2016

Related U.S. Application Data
(60) Provisional application No. 62/258,582, filed on Nov. 23, 2015.

(51) Int. Cl. H01F 27/28; H01F 27/29

(52) U.S. Cl. CPC H01F 27/28; H01F 27/29

(57) ABSTRACT

An inductor module comprising: a first inductor, comprising a first inductor area; and a second inductor, comprising a second inductor area. A first overlapped area of the first inductor area and a second overlapped area of the second inductor area are overlapped. The second overlapped area comprises at least one first magnetic direction area and at least one second magnetic direction area. A ratio between a size of the first magnetic direction area and a size of the second magnetic direction area is a predetermined ratio such that a coupling effect between the first inductor and the second inductor is lower or equals to a predetermined value.

### CROSS REFERENCE TO RELATED APPLICATIONS

This application claims the benefit of U.S. Provisional Application No. 62/258,582, filed on Nov. 23, 2015, the contents of which are incorporated herein by reference.

### BACKGROUND

The present application relates to an inductor and an inductor module, and particularly relates to an inductor and an inductor module which can have a large overlapped region and a low coupling effect.

FIG. 1A, FIG. 1B are schematic diagrams illustrating a layout of an inductor module for related art. The inductor module may comprises more than one inductors, for example, the inductors L_1 and L_2 illustrated in FIG. 1A and FIG. 1B.

The inductors L_1 and L_2 may have an overlapped area OA, which causes coupling effect. The coupling effect means that a magnetic field created by an electrical current flowing through an inductor induces an effect on another inductor. Accordingly, if a low coupling effect is desired, the overlapped region should be minimized. However, if the overlapped area is small, the inductor module may occupy a large area.

### SUMMARY

Therefore, one objective of the present application is to provide an inductor module which has a large overlapped area and low coupling effect.

Another objective is to provide an inductor that can adjust an amount of magnetic flux which provides via setting the structure thereof.

One embodiment of the present application provides an inductor module, which comprises: a first inductor, comprising a first inductor area; and a second inductor, comprising a second inductor area. A first overlapped area of the first inductor area and a second overlapped area of the second inductor area are overlapped. The second overlapped area comprises at least one first magnetic direction area and at least one second magnetic direction area. A ratio between a size of the first magnetic direction area and a size of the second magnetic direction area is a predetermined ratio such that a coupling effect between the first inductor and the second inductor is lower or equals to a predetermined value.

Another embodiment of the present application provides: an inductor comprising: an inductor area, comprising at least one first magnetic direction area and at least one second magnetic direction area. A ratio between a size of the first magnetic direction area and a size of the second magnetic direction area is a predetermined ratio such that a ratio between net magnetic flux caused by the first magnetic direction area and magnetic flux caused by the second magnetic direction is lower or equals to a predetermined threshold.

In view of above-mentioned embodiments, the inductor module can have overlapped areas and low coupling effect. Accordingly, the issue mentioned in the related art can be resolved. Additionally, the coupling effect between two inductors can be controlled via adjusting the structure of the inductor, which causes the inductor module more applicable. Additionally, an inductor that can adjust an amount of magnetic flux which provides via setting the structure thereof is also provided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A, FIG. 1B are schematic diagrams illustrating a layout of an inductor module for related art.

FIG. 2A, FIG. 2B are schematic diagrams illustrating an inductor module according to embodiments of the present application.

FIG. 3A, FIG. 3B are schematic diagrams illustrating the operations for the embodiments illustrated in FIG. 2A and FIG. 2B.

FIG. 4A, FIG. 4B, FIG. 5A, FIG. 5B, FIG. 6A, FIG. 6B, FIG. 7A, FIG. 7B, FIG. 8A, FIG. 8B and FIG. 9 are schematic diagrams illustrating an inductor module according to other embodiments of the present application.

FIG. 10 is a circuit diagram illustrating an exemplary application for the inductor module provided by the present application.

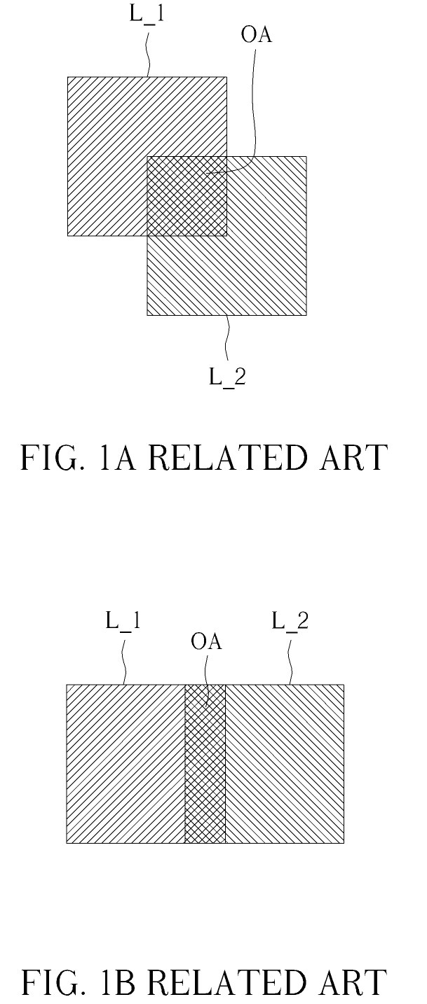

### DETAILED DESCRIPTION

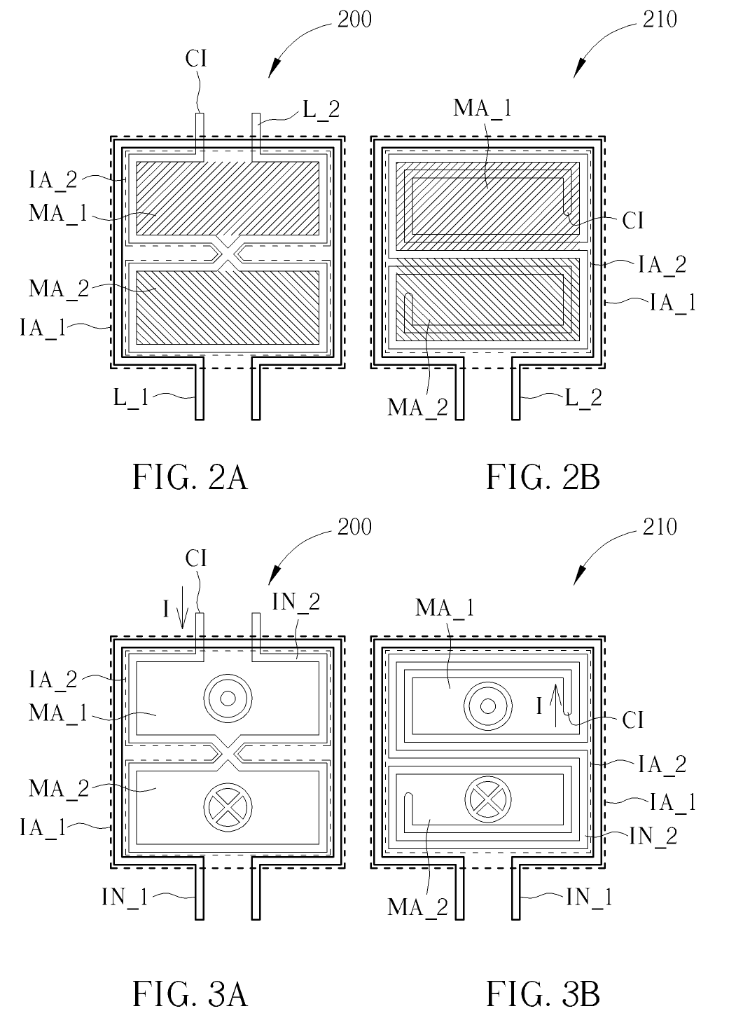

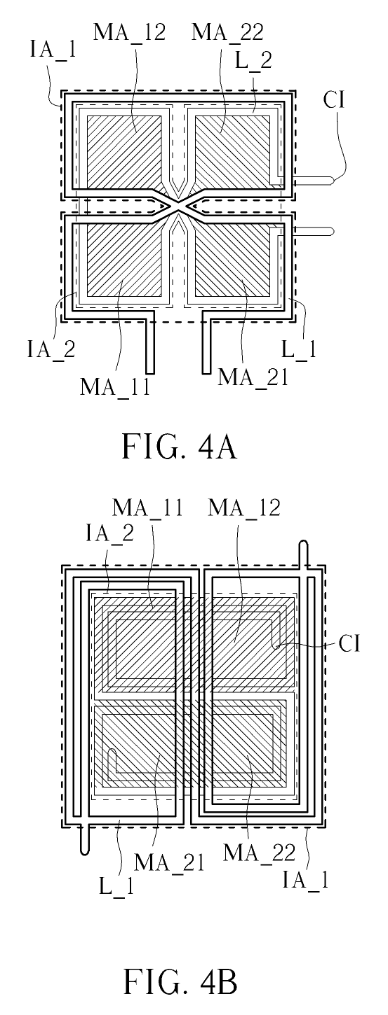

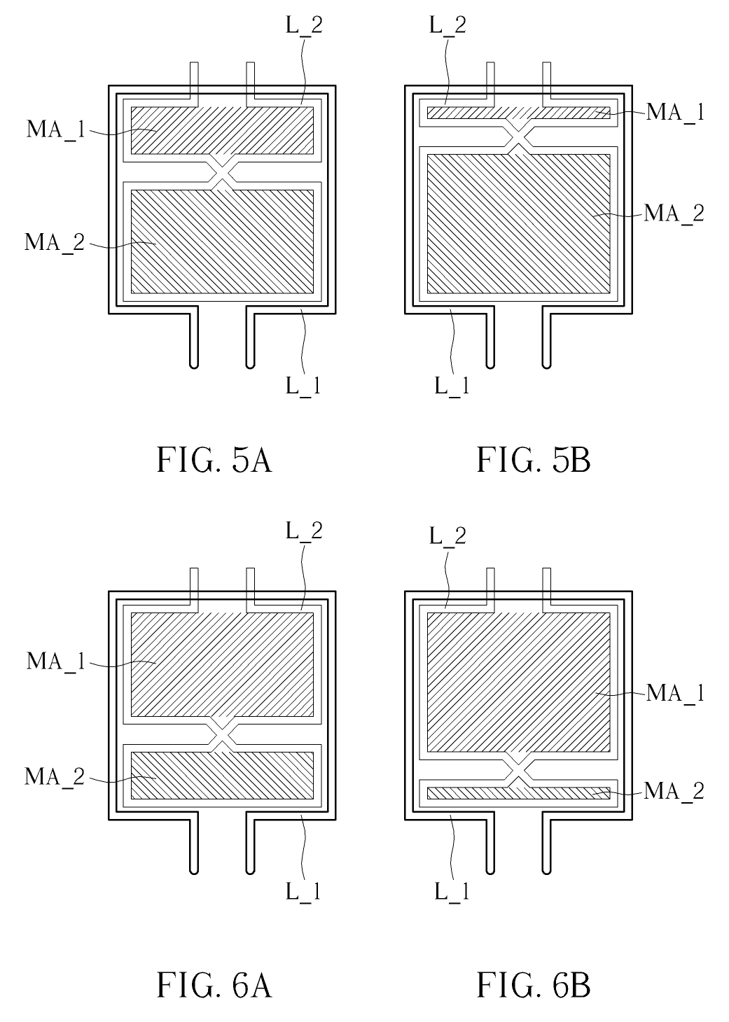

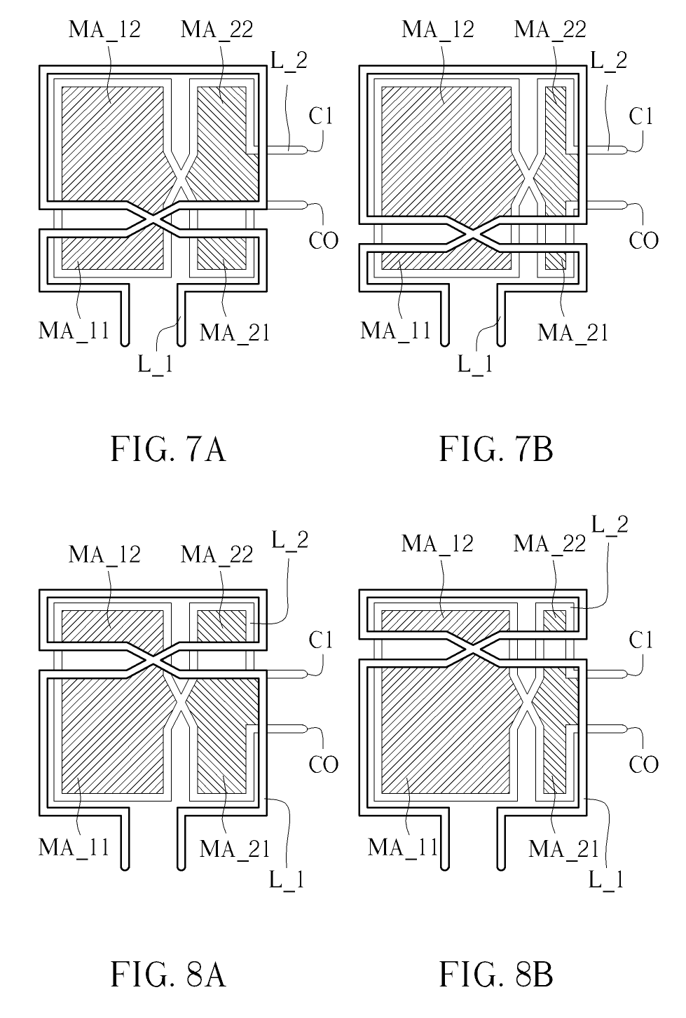

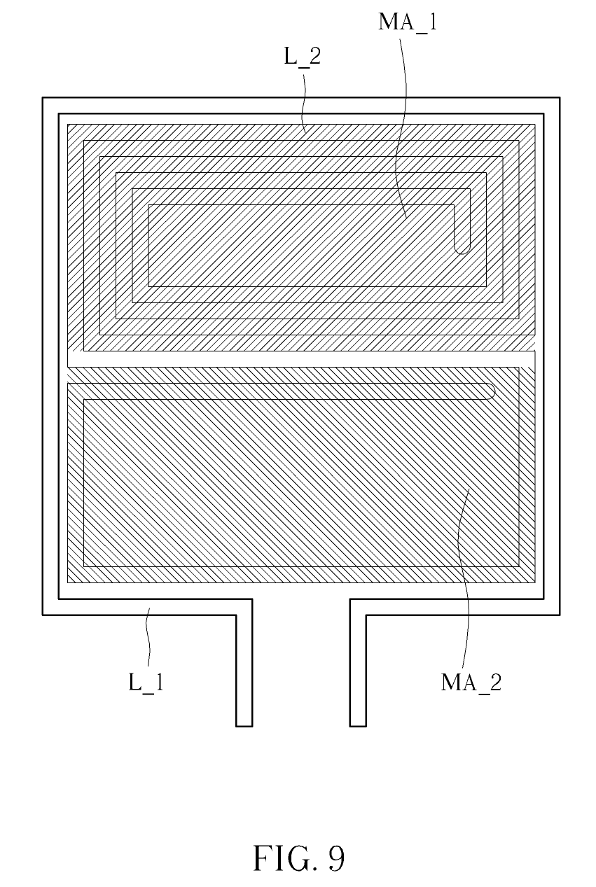

FIG. 2A, FIG. 2B, FIG. 3A, FIG. 3B, FIG. 4A, FIG. 4B, FIG. 5A, FIG. 5B, FIG. 6A, FIG. 6B, FIG. 7A, FIG. 7B, FIG. 8A, FIG. 8Band FIG. 9 are schematic diagrams illustrating an inductor module according to different embodiments of the present application.

As illustrated in FIG. 2A, the inductor module 200 comprises a first inductor L_1 and a second inductor L_2. The first inductor L_1 comprises a first inductor area IA_1, and the second inductor L_2 comprises a second inductor area IA_2. A first overlapped area of the first inductor area IA_1 and a second overlapped area of the second inductor area IA_2 are overlapped. Please note the first overlapped area and the second overlapped area mean the overlapped area of the first inductor area IA_1 and the second inductor area IA_2. However, for the simplification of drawings, the first overlapped area and the second overlapped area are not marked in the drawings.

Also, the second overlapped area comprises at least one first magnetic direction area MA_1 and at least one second magnetic direction area MA_2. Besides, a ratio between a size of the first magnetic direction area MA_1 and a size of the second magnetic direction area MA_2 is a predetermined ratio such that net magnetic flux which the first magnetic direction area MA_1 and the second magnetic direction MA_2 area cause to the first inductor L_1 is lower or equals to a predetermined value. That is, a ratio between a size of the first magnetic direction area MA_1 and a size of the second magnetic direction area MA_2 is a predetermined ratio such that a coupling effect between the first inductor L_1 and the second inductor L_2 is lower or equals to a predetermined value.

Please refer to FIG. 3A, which illustrates operations for the inductor module 200 illustrated in FIG. 2A. As illustrated in FIG. 3A, the direction for the magnetic flux for the first magnetic direction area MA_1, which depends on the current I, is out. Also, the direction for the magnetic flux for the second magnetic direction area MA_2 is in. Besides, a ratio between a size of the first magnetic direction area MA_1 and a size of the second magnetic direction area MA_2 is 1. That is, a size of the first magnetic direction area MA_1 and a size of the second magnetic direction area MA_2 are identical. Therefore, the net magnetic flux that the first magnetic direction area MA_1 and the second magnetic direction area MA_2 is substantially 0, which means the coupling effect between the first inductor L_1 and the second inductor L_2 is substantially 0.

Additionally, in the inductor module 200 illustrated in FIG. 2A, the first magnetic direction area MA_1 and the second magnetic direction area MA_2 form a shape of 8. Also, the coil number for the inductor module 200 illustrated in FIG. 2A is 1. However, the inductor module provided by the present application is not limited to the inductor module 200 illustrated in FIG. 2A. For example, the inductor module 210 illustrated in FIG. 2B has a shape of S, which is different from the structure of the inductor module 200 illustrated in FIG. 2A.

For more detail, the current input terminal CI in FIG. 2A and the current input terminal CI in FIG. 2B have different locations. Also, the coil numbers for the first magnetic direction area MA_1 and the second magnetic direction area MA_2 in in FIG. 2A and the coil numbers for the first magnetic direction area MA_1 and the second magnetic direction area MA_2 in in FIG. 2B are different.

FIG. 3B illustrates the operations for the inductor module 210 illustrated in FIG. 2B. As illustrated in FIG. 3B, the direction of the magnetic flux for the first magnetic direction area MA_1 is out. Also, the direction for the magnetic flux for the second magnetic direction area MA_2 is in. Besides, a ratio between a size of the first magnetic direction area MA_1 and a size of the second magnetic direction area MA_2 is 1. That is, a size of the first magnetic direction area MA_1 and a size of the second magnetic direction area MA_2 are identical. Therefore, the net magnetic flux that the first magnetic direction area MA_1 and the second magnetic direction area MA_2 is substantially 0, which means the coupling effect between the first inductor L_1 and the second inductor L_2 is substantially 0.

Furthermore, the structure of the first inductor L_1 is not limited to the embodiments illustrated in FIG. 2A and FIG. 2B. For example, the first inductor L_1 in the embodiment of FIG. 2A has a square shape. However, the first inductor L_1 in the embodiment FIG. 4A has a shape of 8. In such embodiment, the second over lapped area of the second inductor L_2 is smaller than the second inductor area IA_2. That is, some part of the second inductor area IA_2 is not overlapped with the first inductor area IA_1.

Also, in such embodiment, the second inductor area IA_2 comprises a plurality of first magnetic direction areas MA_11 and MA_12, and a plurality of second magnetic direction areas MA_21 and MA_22. Additionally, in such embodiments, the magnetic flux caused by the first magnetic direction areas MA_11 and the magnetic flux caused by the second magnetic direction areas MA_22 are neutralized. Similarly, the magnetic flux caused by the first magnetic direction areas MA_12 and the magnetic flux caused by the second magnetic direction areas MA_21 are neutralized.

Furthermore, the first inductor L_1 in the embodiment of FIG. 4B comprises a structure the same as the structure for the second inductor L_2 of the embodiment illustrated in FIG. 2B. That is, the coil number for the first inductor L_1 in the embodiment of FIG. 4B is more than one. The operations for the inductor module illustrated in FIG. 4B is similar with the inductor module illustrated in FIG. 2B, thus are omitted for brevity here.

The embodiments illustrated in FIG. 4A, FIG. 4B can be summarized as: the first overlapped area L_1 comprises a third overlapped area (ex. the area comprising the first magnetic direction area MA_11 and the second magnetic direction area MA_21 in FIG. 4A) and a fourth overlapped area (ex. the area comprising the first magnetic direction area MA_12 and the second magnetic direction area MA_22 in FIG. 4A). The third overlapped area overlaps with at least one the first magnetic direction area and at least one the second magnetic direction area. Also, the fourth overlapped area overlaps with at least one the first magnetic direction area and at least one the second magnetic direction area.

In above-mentioned embodiments, a ratio between a size of the first magnetic direction area MA_1 and a size of the second magnetic direction area MA_2 is 1. However, such ratio is not limited to 1. The following embodiments illustrate such cases. Please note, for the simplification of drawings, some symbols such as the first inductor area IA_1 and the second inductor area IA_2 in the embodiments illustrated in FIG. 5A, FIG. 5B, FIG. 6A, FIG. 6B, FIG. 7A, FIG. 7B, FIG. 8A and FIG. 8B are not illustrated.

In the embodiment of FIG. 5A, the first magnetic direction area MA_1 is smaller than the second magnetic direction area MA_2. Also, in the embodiment of FIG. 5B, the first magnetic direction area MA_1 is much smaller than the second magnetic direction area MA_2. On the opposite, in the embodiment of FIG. 6A, the first magnetic direction area MA_1 is larger than the second magnetic direction area MA_2. Also, in the embodiment of FIG. 6B, the first magnetic direction area MA_1 is much larger than the second magnetic direction area MA_2.

The coupling effects for the embodiments illustrated in FIG. 5A and FIG. 6A are weaker than the embodiments illustrated in FIG. 5B and FIG. 6B since the differences between the a size of the first magnetic direction area MA_1 and a size of the second magnetic direction area MA_2 for the embodiments illustrated in FIG. 5A and FIG. 6A are smaller than the differences between the a size of the first magnetic direction area MA_1 and a size of the second magnetic direction area MA_2 for the embodiments illustrated in FIG. 5B and FIG. 6B. Accordingly, the coupling effect for the inductor module can be adjusted via adjusting the ratio between a size of the first magnetic direction area MA_1 and a size of the second magnetic direction area MA_2.

FIG. 7A, FIG. 7B, FIG. 8A and FIG. 8B illustrate other embodiments that the ratio between a size of the first magnetic direction area MA_1 and a size of the second magnetic direction area MA_2 is a positive rational number other than 1. The embodiment illustrated in FIG. 7A is similar with the embodiment illustrated in FIG. 4A. However, a size of the first magnetic direction area MA_11 is smaller than a size of the first magnetic direction area MA_12, and a size of the second magnetic direction area MA_21 is smaller than a size of the second magnetic direction area MA_22, in the embodiment of FIG. 7A. Similarly, a size of the first magnetic direction area MA_11 is much smaller than a size of the first magnetic direction area MA_12, and a size of the second magnetic direction area MA_21 is much smaller than a size of the second magnetic direction area MA_22, in the embodiment of FIG. 7B.

On the contrary, a size of the first magnetic direction area MA_11 is larger than a size of the first magnetic direction area MA_12, and a size of the second magnetic direction area MA_21 is larger than a size of the second magnetic direction area MA_22, in the embodiment of FIG. 8A. Similarly, a size of the first magnetic direction area MA_11 is much larger than a size of the first magnetic direction area MA_12, and a size of the second magnetic direction area MA_21 is much larger than a size of the second magnetic direction area MA_22, in the embodiment of FIG. 8B.

The coupling effects for the embodiments illustrated in FIG. 7A and FIG. 7A are weaker than the embodiments illustrated in FIG. 7B and FIG. 8B since the differences between the sizes of the first magnetic direction areas MA_11, MA_12 and sizes of the second magnetic direction areas MA_21, MA_22 for the embodiments illustrated in FIG. 7A and FIG. 8A are smaller than the differences between the sizes of the first magnetic direction areas MA_11, MA_12 and sizes of the second magnetic direction areas MA_21, MA_22 for the embodiments illustrated in FIG. 7B and FIG. 8B. Accordingly, the coupling effect for the inductor module can be adjusted via adjusting the ratio between a size of the first magnetic direction area MA_1 and a size of the second magnetic direction area MA_2.

It will be appreciated that the embodiments illustrated in FIG. 7A, FIG. 7B, FIG. 8A and FIG. 8B can be summarized as: the second overlapped area L_2 comprises a current input terminal CI and a current output terminal CO (the locations of CI and CO can be swapped). Sizes of the second magnetic direction areas MA_21, MA_22 which are closer to the current input terminal CI and the current output terminal CO than the first magnetic direction areas MA_11, MA_12 are smaller (in another embodiment, larger) than sizes of the first magnetic direction area MA_11, MA_12.

Besides, the embodiments illustrated in FIG. 7A, FIG. 7B, FIG. 8A and FIG. 8B can be summarized as: the first overlapped area L_1 comprises a third overlapped area (ex. the area comprising the first magnetic direction area MA_11 and the second magnetic direction area MA_21 in FIG. 7A) and a fourth overlapped area (ex. the area comprising the first magnetic direction area MA_12 and the second magnetic direction area MA_22 in FIG. 7A). The third overlapped area overlaps with at least one the first magnetic direction area and at least one the second magnetic direction area. Also, the fourth overlapped area overlaps with at least one the first magnetic direction area and at least one the second magnetic direction area. Additionally, the first magnetic direction area overlapping with the third overlapped area (ex. MA_11 in FIG. 7A) and the second magnetic direction area (ex. MA_21 in FIG. 7A) overlapping with the third overlapped area have different sizes.

In above-mentioned embodiments, the coil number for the first magnetic direction area and coil number for the second magnetic direction area are identical. For example, either the coil number for the first magnetic direction area MA_1 or the coil number for the second magnetic direction area MA_2 are 1 in FIG. 2A, and either the coil number for the first magnetic direction area MA_1 or the coil number for the second magnetic direction area MA_2 are 2 in FIG. 2B. However, the coil number for the first magnetic direction area and coil number for the second magnetic direction area can be different.

Please refer to FIG. 9, the coil number for the first magnetic direction area MA_1 is larger than the coil number for the second magnetic direction area MA_2. Accordingly, the first magnetic direction area MA_1 causes a magnetic flux stronger than the magnetic flux caused by the second magnetic direction area MA_2 even if the size for the first magnetic direction area MA_1 and the size for the second magnetic direction area MA_2 are the same. Similarly, the first magnetic direction area MA_1 may cause a magnetic flux the same as the magnetic flux caused by the second magnetic direction area MA_2 even if the size for the first magnetic direction area MA_1 and the size for the second magnetic direction area MA_2 are different, via assigning different coil numbers to the first magnetic direction area MA_1 and the second magnetic direction area MA_2.

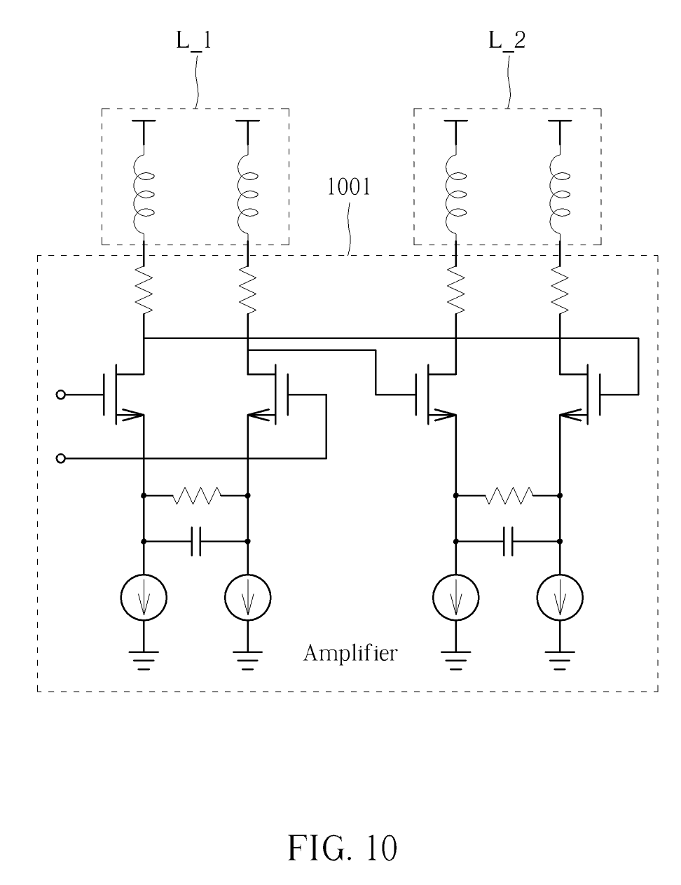

FIG. 10 is a circuit diagram illustrating an exemplary application for the inductor module provided by the present application. As illustrated in FIG. 10, the inductors L_1, L_2 are applied to an amplifier 1001. The inductors L_1, L_2 can have overlapped areas illustrated in above-mentioned embodiments. However, the inductors provided by the present application are not limited to be applied to an amplifier.

Please note, the above-mentioned second inductor L 2 is not limited to be applied with the inductor L_1. The second inductor L_2 illustrated in different embodiments can be summarized as: an inductor, comprising: an inductor area, comprising at least one first magnetic direction area and at least one second magnetic direction area. A ratio between a size of the first magnetic direction area and a size of the second magnetic direction area is a predetermined ratio such that a ratio between net magnetic flux caused by the first magnetic direction area and magnetic flux caused by the second magnetic direction is lower or equals to a predetermined threshold.

In view of above-mentioned embodiments, the inductor module can have overlapped areas and low coupling effect. Accordingly, the issue mentioned in the related art can be resolved. Additionally, the coupling effect between two inductors can be controlled via adjusting the structure of the inductor, which causes the inductor module more applicable. Additionally, an inductor that can adjust an amount of magnetic flux which provides via setting the structure thereof is also provided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inductor module, comprising:
a first inductor, comprising a first inductor area; and
a second inductor, comprising a second inductor area;
wherein a first overlapped area of the first inductor area and a second overlapped area of the second inductor area are overlapped;
wherein the second overlapped area comprises at least one first magnetic direction area and at least one second magnetic direction area;
wherein a ratio between a size of the first magnetic direction area and a size of the second magnetic direction area is a predetermined ratio such that a coupling effect between the first inductor and the second inductor is lower or equals to a predetermined value.

2. The inductor module of claim 1, wherein the predetermined value is 0.

3. The inductor module of claim 1, wherein the predetermined ratio is 1.

4. The inductor module of claim 1, wherein the predetermined ratio is a positive rational number other than 1.

5. The inductor module of claim 1, wherein the first overlapped area comprises a third overlapped area and a fourth overlapped area, wherein the third overlapped area overlaps with at least one the first magnetic direction area and at least one the second magnetic direction area, wherein the fourth overlapped area overlaps with at least one the first magnetic direction area and at least one the second magnetic direction area.

6. The inductor module of claim 5, wherein the first magnetic direction area overlapping with the third overlapped area and the second magnetic direction area overlapping with the third overlapped area have different sizes.

7. The inductor module of claim 1, wherein the second inductor area is larger than the second overlapped area.

8. The inductor module of claim 1, wherein the second overlapped area comprises a current input terminal and a current output terminal, wherein sizes of the second magnetic direction areas which are closer to the current input terminal and the current output terminal than the first magnetic direction areas are smaller than sizes of the first magnetic direction area.

9. The inductor module of claim 1, wherein the second overlapped area comprises a current input terminal and a current output terminal, wherein sizes of the second magnetic direction areas which are closer to the current input terminal and the current output terminal than the first magnetic direction areas are larger than sizes of the first magnetic direction area.

10. The inductor module of claim 1, wherein a coil number of the first magnetic direction area is larger than a coil number of the second magnetic direction area.

11. The inductor module of claim 1, wherein at least one of the first inductor area and the second inductor area has a shape of 8.

12. The inductor module of claim 1, wherein at least one of the first inductor area and the second inductor area has a shape of S.

13. An inductor, comprising:
an inductor area, comprising at least one first magnetic direction area and at least one second magnetic direction area;
wherein a ratio between a size of the first magnetic direction area and a size of the second magnetic direction area is a predetermined ratio such that a ratio between net magnetic flux caused by the first magnetic direction area and magnetic flux caused by the second magnetic direction is lower or equals to a predetermined threshold.

14. The inductor of claim 13, wherein the predetermined ratio is 1.

15. The inductor of claim 13, wherein the predetermined ratio is a positive rational number other than 1.

16. The inductor of claim 13, wherein a coil number of the first magnetic direction area is larger than a coil number of the second magnetic direction area.

17. The inductor of claim 13, comprising a current input terminal and a current output terminal, wherein sizes of the second magnetic direction areas which are closer to the current input terminal and the current output terminal than the first magnetic direction areas are smaller than sizes of the first magnetic direction area.

18. The inductor of claim 13, comprising a current input terminal and a current output terminal, wherein sizes of the second magnetic direction areas which are closer to the current input terminal and the current output terminal than the first magnetic direction areas are larger than sizes of the first magnetic direction area.

19. The inductor of claim 13, wherein the inductor area has a shape of 8.

20. The inductor of claim 13, wherein the inductor area has a shape of S.
